(19) United States
(12) Patent Application Publication
(10) Pub. No.: US 2008/0134832 A1
(43) Pub. Date: Jun. 12, 2008

(54) STEERING WHEEL WITH REDUCED VIBRATION TRANSMISSION

(75) Inventors: Richard L. MATSU, Plymouth, MI (US); Patrick E. PATERCSAK, Davisburg, MI (US)

Correspondence Address: HARNESS, DICKEY & PIERCE, P.L.C., P.O. BOX 828, BLOOMFIELD HILLS, MI, 48303, US

(73) Assignee: Autoliv ASP, INC., Ogden, UT (US)

(21) Appl. No.: 11/609,494

(22) Filed: Dec. 12, 2006

(51) Int. Cl. B62D 1/04; G05G 1/10

(52) U.S. Cl. 74/552; 74/491

(57) ABSTRACT

A steering wheel for a vehicle includes a rim defining a perimeter of the steering wheel and a weighted cable positioned proximate to and at least partially surrounding the rim. The weighted cable increases the polar moment of inertia of the steering wheel and, in so doing, minimizes vibration of the steering wheel caused by operation and movement of the vehicle.

### FIELD

The present teachings generally relate to a steering wheel for a motor vehicle. More particularly, the present teachings relate to a steering wheel for a motor vehicle that reduces the transmission of vehicle vibrations to the driver.

### INTRODUCTION

The statements in this section merely provide introduction information related to the present disclosure and may not constitute prior art.

Motor vehicles include various components that rotate, oscillate, and otherwise move in various directions. The movement of these components produces vibrations that can be transferred throughout the vehicle. The engine, for example, can be a source of significant vehicle vibrations. While it may be possible to reduce the vibrations of the engine by altering the RPMs (revolutions per minute) of the engine, for example, these alterations may adversely affect fuel economy or performance of the vehicle.

An additional source of vehicle vibration results from contact between the vehicle and the driving surface. A number of variables affect the vibrations generated by contract with the driving surface. For example, vehicle speed, aberrations in the driving surface, wheel alignment, and uneven tire wear can significantly impact the vibrations generated in the vehicle. To address this problem, a number of shock absorbing and damping systems have been developed to enhance the suspension systems of vehicles. Nevertheless, a need remains for further vibration control.

### SUMMARY

According to one aspect, the present teachings provide a steering wheel for a vehicle including a rim defining a perimeter of the steering wheel and a weighted cable positioned proximate to and at least partially surrounding the rim. The weighted cable increases the polar moment of inertia of the steering wheel and, in so doing, minimizes vibration of the steering wheel caused by operation and movement of the vehicle.

According to another aspect, the present teachings provide a steering wheel for a vehicle including a rim that defines a perimeter of the wheel and includes a front side and a rear side. A flexible member is positioned on the rear side of the rim and substantially surrounds the rim. The flexible member increases the polar moment of inertia of the steering wheel and, in so doing, minimizes vibration of the steering wheel caused by operation and movement of the vehicle.

According to yet another aspect, a steering wheel for a vehicle includes a rim that defines a perimeter of the steering wheel and includes a front side and a rear side. A continuous member is positioned adjacent the rear side of the rim and substantially surrounds a perimeter of the rim. The continuous member increases the polar moment of inertia of the steering wheel and, in so doing, minimizes vibration of the steering wheel caused by operation and movement of the vehicle.

Further areas of applicability of the present teachings will become apparent from the description and appended claims provided hereinafter. It should be understood that the detailed description and specific examples, while indicating the various examples of the present teachings, are intended for purposes of illustration only and are not intended to limit the scope of the teachings.

### DRAWINGS

The present teachings will become more fully understood from the detailed description, the appended claims and the following drawings.

FIG. 1 is a perspective view of a steering wheel operatively associated with an exemplary motor vehicle in accordance with the present teachings with the steering wheel being shown partially cut-away for purposes of illustration.

FIG. 2 is an enlarged front view of the steering wheel of FIG. 1 with the steering wheel again being shown partially cut-away.

FIG. 3 is a cross-sectional view taken along the line 3-3 of FIG. 2

FIG. 4 is a front view of a frame of the steering wheel in accordance with the present teachings.

### DESCRIPTION OF VARIOUS ASPECTS

The following description is merely exemplary in nature and is not intended to limit the present disclosure. It will be understood that corresponding reference numerals indicate like or corresponding parts and features throughout the drawings. The description and any specific examples, while indicating embodiments of the present disclosure, are intended for purposes of illustration only and are not intended to limit the scope of the present disclosure. Moreover, recitation of embodiments having stated features is not intended to exclude other embodiments having additional features, or other embodiments incorporating different combinations of the stated features.

With general reference to FIGS. 1 through 4 of the drawings, a steering wheel in accordance with the present teachings is generally identified at reference character 10. In FIG. 1, the steering wheel 10 is shown operatively associated with a motor vehicle 12 The particular motor vehicle 12 shown in the drawings will be understood to be exemplary in nature. In this regard, the present teachings have application to various other motor vehicles. The steering wheel 10 may be conventionally coupled to a steering column 14, which may in turn, be coupled to wheels (not shown) of the vehicle 12 such that rotation of the steering wheel 10 results in redirection of the wheels of the vehicle 12.

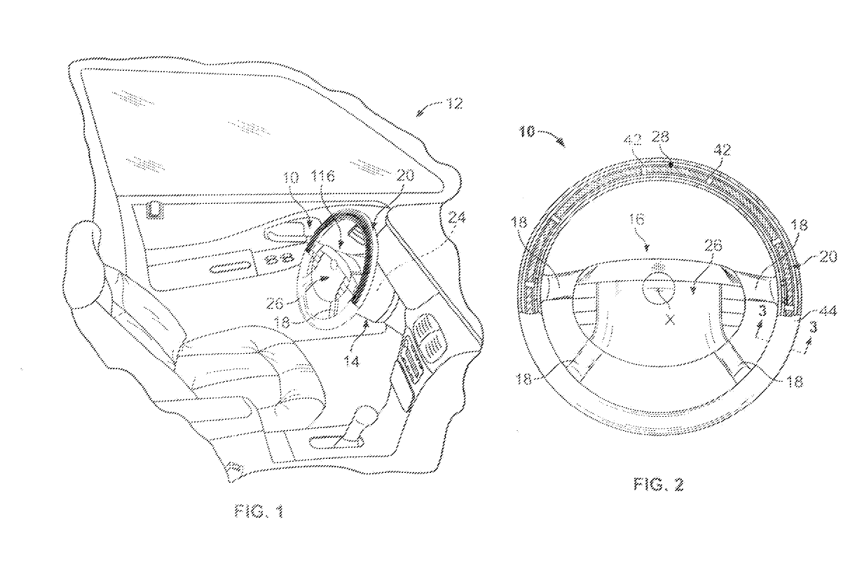

The steering wheel 10 may generally include a central member 16, a series of spokes 18, and an outer rim 20. The central member 16 may include a hub 22 that connects the steering wheel 10 to a rotatable portion 24 of the steering column 14. The hub 22 may include at least one of a series of splines (not shown) or a keyed aperture 23 that fixes the steering column 10 for rotation with the rotatable portion 24 of the steering column 14. The central member 10 may also include various instruments and components such as a horn, driver's side airbag, stereo controls, and cruise control buttons, schematically represented by reference number 26 (see, e.g., FIGS. 1 and 2).

The spokes 18 extend generally from the central member 16 and connect the central member 16 to the rim 20. The spokes 18 may be integrally formed with the central member 16 and/or rim 20 by a suitable manufacturing process such as casting. Alternatively, the spokes 18 may be separately formed from the central member 16 and/or rim 20 and fixedly attached to the central member 16 and/or rim 20 by a weld and/or a mechanical fastener. While the spokes 18 are described as connecting the rim 20 to the central member 16, the central member 16 may alternatively radially extend and engage the outer rim 20 or may be integrated formed with the outer rim 20.

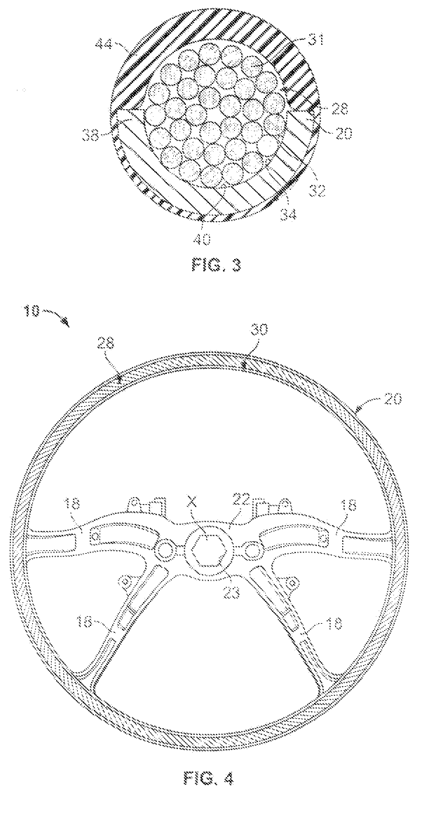

With particular reference to FIGS. 3 and 4, the rim 20 axially surrounds the central member 16 and the spokes 18 and defines a perimeter of the steering wheel 10. In this regard, at least a portion of the perimeter of the steering wheel is defined by the rim 20. The rim 20 may extend completely around the central member 16 and the spokes 18. Alternatively, the rim 20 may only extend partially around the central member 16 an the spokes 18.

The rim 20 may include a generally circular shape and a weighted member 28 that at least partially surrounds a perimeter of the rim 20. The weighted member 28 may be formed of a flexible material such as, but not limited to, a braided, steel cable. While the weighted member 28 may be formed of any material that adequately increases the polar moment of inertia of the steering wheel 10 as described below, the weighted member 28 will be described hereinafter and shown in the drawings as a braided cable 28.

The braided cable 28 may be positioned proximate the rim 20 of the steering wheel 10 generally on a rear surface 30 that opposes an occupant of the motor vehicle 12. Alternatively, the braided cable 20 may be located on a front surface 32 of the rim 20 that is generally formed on an opposite side of the rim 20 from surface 30. The cable 28 may completely surround a perimeter of the rim 20, may only partially surround the rim 20, or may include individual segments disposed at predetermined locations around the perimeter of the rim 20

In any configuration, because the braided cable 28 is constructed of a plurality of individual strands 31, the cable 28 is relatively flexible along its length. The flexibility of the cable 28 allows the cable 28 to move in a direction generally perpendicular to surfaces 30, 32 and therefore does not significantly affect the bending stiffness of the rim 20. Explaining further, the cable 28 is relatively flexible in a direction generally parallel to a plane defined by the perimeter of the rim 20.

The braided cable 28 may be received within a groove 34 formed in the rim 20. The groove 34 may include a shape that matingly receives the cable 28 such that a width of the groove 34 is approximately equal to a diameter of the cable 28. The groove 34 may be cast into the shape of the rim 20 or, alternatively, may be machined into the rim 20 subsequent to formation of the rim 20.

Positioning of the cable 28 proximate the rim 20 increases the polar moment of inertia of the steering wheel 10 and, as such, reduces vibration of the steering wheel 10 during operation of the vehicle 12. The polar moment of inertia is generally defined as a measure of a beam's ability to resist torsion. In the present application, providing the steering wheel 10 with a high polar moment of inertia reduces the willingness of the steering wheel 10 to change direction and, thus, helps prevent movement of the rim 20 otherwise caused by vibrational forces applied thereto. Because the steering wheel 10 includes a generally circular shape, positioning the cable 28 at the greatest possible radius (i.e., around the outer perimeter of the rim 20) achieves the greatest polar moment of inertia as the weight (i.e., cable 28) is located the greatest distance from a central axis of rotation X of the steering wheel 10.

In one application, the cable 28 may be a steel braided cable. Any weighted cable will serve to reduce at least some vibration in accordance with the present disclosure. For a steering wheel having a diameter of 380 mm, the cable preferably has a weight of at least approximately 100 grams and more preferably has a weight of at least approximately 200 grams.

The rim 20 may include a retention device that fixedly attaches the cable 28 to either or both of surfaces 30, 32. The retention device may be integrally or otherwise formed with the groove 34 and may include a pair of arms 38 that extend from a bottom portion 40 of the groove 34 to provide the rim 20 will a cross-section that includes a generally U-shape. The arms 38 may be configured to receive the cable 28 such that the cable 28 is snap-fit into the groove 34 and held therein by the arms 38. The arms 38 may restrict removal of the cable 28 from the groove 34 and ensure proper placement of the cable 28 relative to the rim 20 during manufacturing. While the retention device is illustrated as including a pair of arms 38 that cooperate with a bottom portion 40 of a groove 34 to prevent removal of the cable 28 from the groove 34, the retention device may alternatively or additionally include tape or a mechanical fastener such as a threaded bolt or weld to restrict removal of the cable 28 from the groove 34. Such additional fasteners may further increase the polar moment of inertia and may therefore improve the performance of the steering wheel 10.

During manufacturing, the cable 28 may be held in place on the rim 20 by a removable fastener 42. The removable fastener 42 holds the cable 28 in a predetermined location around the perimeter of the rim 20 prior to application of an overcoat material 44 that fixedly attaches the cable 28 to the rim 20. The removable fastener 42 may include tape or wire that at least temporarily maintains a position of the cable 28 relative to the rim 20 prior to and during application of an overcoat material 44 to the rim 20 and cable 28. The overcoat material 44 may be any suitable material that attaches the cable 28 to the rim 20 and at least temporarily maintains a position of the cable 28 relative to the rim 20, such as, but not limited to, molded foam or polyurethane. The overcoat material 44 may encapsulate the rim 20 and the cable 28.

As described, the cable 28 increases the polar moment of inertia of the steering wheel 10 and helps reduce movement of the steering wheel 10 when subjected to vibrational forces. Because the cable 28 is not cast integrally with the rim 20, but rather, is added to a surface or surfaces 30, 32 of the rim 20, the weight, size, location, and shape of the cable 28 may all be tuned during design of the steering wheel 10 to improve the performance of the steering wheel 10 without requiring modifications to the rim 20. Preventing such modification to the rim 20 prevents modifications to associated tooling used to manufacture the rim 20 and, therefore, reduces the overall cost and complexity associated with designing and manufacturing the steering wheel 10.

While specific examples have been described in the specification and illustrated in the drawings, it will be understood by those skilled in the art that various changes may be made and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular illustrated by the drawings and described in the specification as the best mode of presently contemplated for carrying out the present teachings but that the scope of the present disclosure will include any embodiments following within the foregoing description and the appended claims.

What is claimed is:

1. A steering wheel for a vehicle comprising:
a rim defining a perimeter of the steering wheel; and
a weighted cable positioned proximate to and at least partially surrounding the rim;
wherein the weighted cable increases the polar moment of inertia of the steering wheel.

2. The steering wheel of claim 1, wherein the rim defines a groove that matingly receives the cable.

3. The steering wheel of claim 2, wherein the at least one groove includes a retention feature for retaining the cable within the groove.

4. The steering wheel of claim 1, further comprising a material encapsulating the rim and the cable.

5. The steering wheel of claim 1, wherein the cable is a braided, steel cable.

6. The steering wheel of claim 1, wherein the rim includes a front side and a rear side, the cable positioned adjacent the rear side.

7. The steering wheel of claim 1, wherein the cable is flexible in a direction generally perpendicular to a plane defined by the perimeter of the steering wheel.

8. A steering wheel for a vehicle comprising:
a rim defining a perimeter of the steering wheel and including a front side and a rear side; and
a flexible member positioned on the rear side of the rim and substantially surround the rim;
wherein the flexible member increases the polar moment of inertia of the steering wheel.

9. The steering wheel of claim 8, wherein the rim defines a groove that matingly receives the flexible member.

10. The steering wheel of claim 9, wherein the groove includes a retention feature for retaining the flexible member within the groove.

11. The steering wheel of claim 9, wherein the flexible member is snap-fit into the groove.

12. The steering wheel of claim 8, wherein the flexible member is flexible in a direction generally perpendicular to a plane defined by the perimeter of the steering wheel.

13. The steering wheel of claim 12, wherein the flexible member is a braided, steel cable.

14. A steering wheel for a vehicle comprising:
a rim defining a perimeter of the steering wheel and including a front side and a rear side; and
a continuous member positioned adjacent said rear side of the rim and substantially surrounding a perimeter of the rim;
wherein the continuous member increases the polar moment of inertia of the steering wheel.

15. The steering wheel of claim 14, wherein the rim includes a groove that receives the continuous member

16. The steering wheel of claim 15, wherein the groove includes a retention feature for retaining the continuous member in the groove.

17. The steering wheel of claim 14, further comprising a material encapsulating the rim and the continuous member.

18. The steering wheel of claim 17, wherein the continuous member is a cable.

19. The steering wheel of claim 18, wherein the cable is a braided, steel cable.

20. The steering wheel of claim 14, wherein the continuous member is relatively flexible in a direction generally perpendicular to a plane defined by a perimeter of the steering wheel.
